(19) United States
(12) Patent Application Publication
(10) Pub. No.: US 2014/0075376 A1
(43) Pub. Date: Mar. 13, 2014

(54) DISPLAY CONTROL APPARATUS, STORAGE MEDIUM, DISPLAY CONTROL SYSTEM, AND DISPLAY METHOD

(71) Applicant: NINTENDO CO., LTD., Kyoto (JP)

(72) Inventors: Munetaka TSUDA, Kyoto (JP); Yasuto KAKIMOTO, Kyoto (JP); Ryoma AOKI, Kyoto (JP)

(73) Assignee: NINTENDO CO., LTD., Kyoto (JP)

(21) Appl. No.: 13/827,051

(22) Filed: Mar. 14, 2013

(30) Foreign Application Priority Data
Sep. 11, 2012 (JP) 2012-199956

(51) Int. Cl. G06F 3/0485

(52) U.S. Cl. CPC G06F 3/04855
USPC 715/787

(57) ABSTRACT

An example display control apparatus includes: a first display controller that displays a portion of content in a predetermined area in a display area; a position detector that detects a position of the portion of content being displayed in the predetermined area; and a second display controller that, if the display area includes a blank area in which the portion of content is not being displayed, displays a scroll indicator indicative of the detected position in the blank area, and if the display area does not include the blank area, prevents display of the scroll indicator.

### CROSS-REFERENCE TO RELATED APPLICATIONS

This application is based on and claims priority under 35 U.S.C. 119 from Japanese Patent Application No. 2012-199956, which was filed on Sep. 11, 2012.

### FIELD

The present application relates to technology for assisting content browsing.

### BACKGROUND AND SUMMARY

An object called a scrollbar is known as a GUI (computer Graphical User Interface). If the entirety of information (content) that is to be displayed cannot fit into a predetermined area in a window system or the like, a scrollbar object is used to indicate the position that is currently being displayed and to scroll the information displayed on the screen by performing a drag operation or the like.

The application provides a display control apparatus including: a first display controller that displays a portion of content in a predetermined area in a display area; a position detector that detects a position of the portion of content being displayed in the predetermined area; and a second display controller that, if the display area includes a blank area in which the portion of content is not being displayed, displays a scroll indicator indicative of the detected position in the blank area, and if the display area does not include the blank area, prevents display of the scroll indicator.

### BRIEF DESCRIPTION OF THE DRAWINGS

FIG. 1 is an example non-limiting block diagram showing a functional configuration of a display control apparatus;

FIG. 2 is an example non-limiting block diagram showing a hardware configuration of an information processing apparatus;

FIG. 3 is an example non-limiting diagram showing an example of a web page display method;

FIG. 4 is an example non-limiting diagram showing an example of a web page display method;

FIG. 5 is an example non-limiting diagram for describing a relationship between the displayed position of a web page and the position of a scroll indicator;

FIG. 6 is an example non-limiting flowchart showing display control;

FIG. 7 is an example non-limiting flowchart showing display control;

FIG. 8 is an example non-limiting diagram showing an example of content display; and

FIG. 9 is an example non-limiting diagram showing an example of a layer structure.

### DETAILED DESCRIPTION OF NON-LIMITING EXAMPLE EMBODIMENT

### 1. Summary of the Exemplified Embodiment

A feature of the present technology relates to display control for displaying an indicator when content such as a web page is displayed. “Indicator” as used herein refers to an image that indicates the position of the portion of content that is being displayed when the content is partially displayed in a display area. The indicator has an appearance similar to objects called a scrollbar and a scroll indicator, for example. By viewing the indicator, a user can find out which position in the content corresponds to the content being partially displayed in the display area.

Another feature of the present technology is that when a second area, which is an area different from a first area in which content is displayed, is included in the display area, the indicator is displayed in the second area. Here, the second area corresponds to a background or blank space from the viewpoint of the first area. In other words, the second area can also be said to be a sub area relative to the main first area. According to the present technology, by displaying the indicator in the second area and not in the first area, it is possible to prevent the indicator from hindering the view of the content due to being displayed superimposed on the content.

The display of such an object is realized by the following configuration, for example.

FIG. 1 is a block diagram showing the functional configuration of display control apparatus 10 according to the present embodiment. Display control apparatus 10 is built into an information processing apparatus that has input device 20 and display unit 30, or is configured separately from input device 20 and display unit 30. Input device 20 is a unit for inputting user operations to display control apparatus 10. Display unit 30 is a unit for displaying images in a display area. Also, display control apparatus 10 includes display controller 11, position detector 12, operation detector 13, and modification unit 14.

Display controller 11 is a unit for displaying images on display unit 30. Display controller 11 displays content and the indicator in the display area of display unit 30. Display controller 11 changes the display of the content and the indicator in accordance with user operations and the like.

Position detector 12 is a unit for detecting the displayed position of content. Here, the displayed position of content refers to the position of the portion of content that is currently being displayed in the display area. Note that sometimes the entirety of the content is displayed in the display area, and sometimes only a portion of the content is displayed in the display area.

Also, position detector 12 may detect a content displayed position in a first direction and a displayed position in a second direction that intersects with the first direction. Here, assuming that a two-dimensional orthogonal coordinate system is defined in the display area, the first direction refers to the direction of one of the axes, and the second direction refers to the direction of the other axis in the orthogonal coordinate system. Typically, if the display area of display unit 30 is rectangular, the first direction and the second direction respectively correspond to the short-side direction and the long-side direction.

Operation detector 13 is a unit for detecting user operations. Operation detector 13 detects user operations based on input from input device 20. Operation detector 13 detects at least an operation for scrolling content (referred to hereinafter as a “scroll operation”). Operation detector 13 can also detect an operation for modifying the size of the first area (referred to hereinafter as a “size modification operation”).

Modification unit 14 is a unit for modifying the size of the first area. Modification unit 14 performs control so as to cause display controller 11 to modify the size of the first area in accordance with a predetermined operation detected by operation detector 13. Modification unit 14 can also increase and decrease the size of the first area, and can also modify the size of the first area in only either the first direction or the second direction. Note that the modification performed by modification unit 14 may accompany a modification of the size of the content displayed in the first area, and a configuration is possible in which the modification does not accompany a modification of the size of the content. In other words, modification unit 14 may modify only the size of the first area, without modifying the size of the content displayed in the first area.

According to a configuration such as this, display control apparatus 10 controls display unit 30 so as to display the content in the first area, and also receives operations from a user. Display control apparatus 10 can modify the size of the first area in accordance with a user operation. Display control apparatus 10 then displays the indicator in an area (the second area) other than the first area if that area exists in the display area due to, for example, the user performing an operation for reducing the size of the first area. Display control apparatus 10 can therefore display the indicator so as to not hinder the view of the content.

### 2. Detailed Exemplary Embodiments

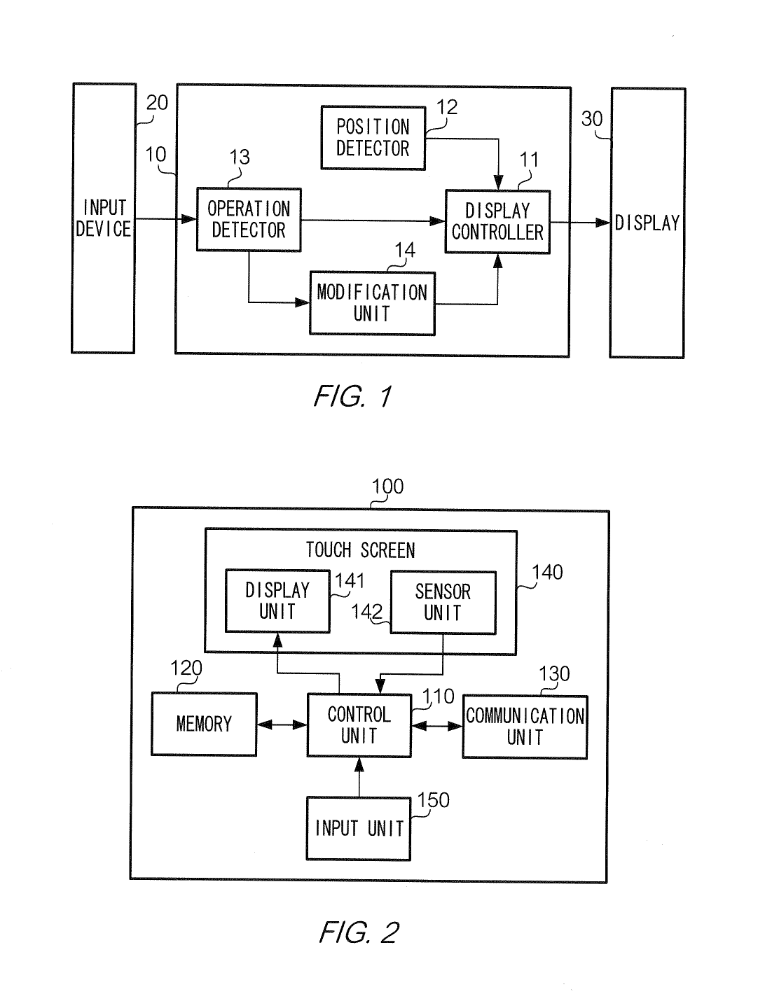

FIG. 2 is a block diagram showing the hardware configuration of information processing apparatus 100 according to an embodiment of the present embodiment. In the present embodiment, information processing apparatus 100 is a handheld gaming device, that is to say, a gaming device small enough to be operated while held in the user's hands. Information processing apparatus 100 includes control unit 110, memory 120, communication unit 130, touch screen 140, and input unit 150.

Control unit 110 is a unit for controlling operations of the units of information processing apparatus 100. Control unit 110 includes a memory and an arithmetic processing unit such as a CPU (Central Processing Unit), and performs control by executing a predetermined program. Memory 120 is a unit for storing data. Memory 120 includes a recording medium such as a hard disk or a flash memory, and stores data used by control unit 110. Memory 120 stores a program (application program) for realizing functions that correspond to a so-called web browser. Communication unit 130 is a unit for transmitting and receiving data. Communication unit 130 connects to other information processing apparatuses and a network such as the Internet or a LAN (Local Area Network), and exchanges data with connection destinations.

Touch screen 140 is a unit for displaying images and receiving user operations. Touch screen 140 includes display unit 141 and sensor unit 142. Display unit 141 includes a display area (display panel) configured by a liquid crystal device or an organic EL (electroluminescence) device and drive circuitry thereof, and displays images that correspond to display data supplied by control unit 110. Sensor unit 142 includes sensors provided in correspondence with the display area of display unit 141, and supplies control unit 110 with coordinate data that corresponds to operations with respect to the display area. This coordinate data is data that indicates a position in the display area that was instructed by the user, and indicates that position with coordinates in a predetermined coordinate system (e.g., a two-dimensional orthogonal coordinate system). Note that although the user operations referred to here are operations performed by touching the display area (referred to hereinafter as “touch operations”), the user operations may be operations performed by merely approaching the display area without touching it. Also, the user operations may be performed with a body part such as a finger, or may be performed with an instrument such as a stylus (touch pen). Note that the display area of display unit 141 is shaped as a horizontally-long rectangle in the present embodiment.

Input unit 150 is a unit for receiving user operations. Input unit 150 includes keys (also referred to as buttons) such as direction keys (arrow keys), and supplies control unit 110 with key data that corresponds to user operations. This key data is data that indicates the pressed state of keys (whether they are being pressed), for example.

Note that information processing apparatus 100 may be configured including only either sensor unit 142 or input unit 150. Also, the coordinate data and the key data are collectively referred to as “operation data” in the following description. This operation data is data that expresses user operations.

Information processing apparatus 100 of the present embodiment has a configuration including above-described display control apparatus 10, input device 20, and display unit 30. Here, control unit 110 corresponds to an example of display control apparatus 10 that has display controller 11, position detector 12, operation detector 13, and modification unit 14. Also, input unit 150 corresponds to an example of input device 20, and touch screen 140 corresponds to an example of input device 20 and display unit 30.

Information processing apparatus 100 has the following configuration. According to this configuration, information processing apparatus 100 displays images in accordance with user operations. In the present embodiment, information processing apparatus 100 has a function for displaying web pages, that is to say, a web browser function. Here, a web page corresponds to one example of content of the present embodiment.

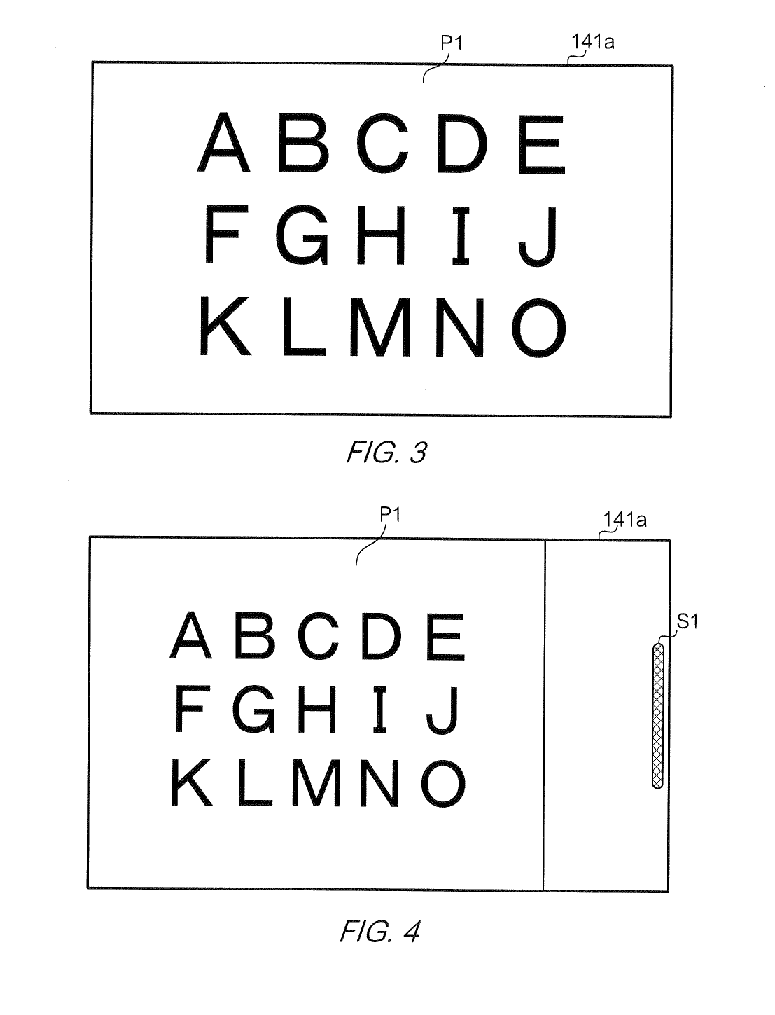

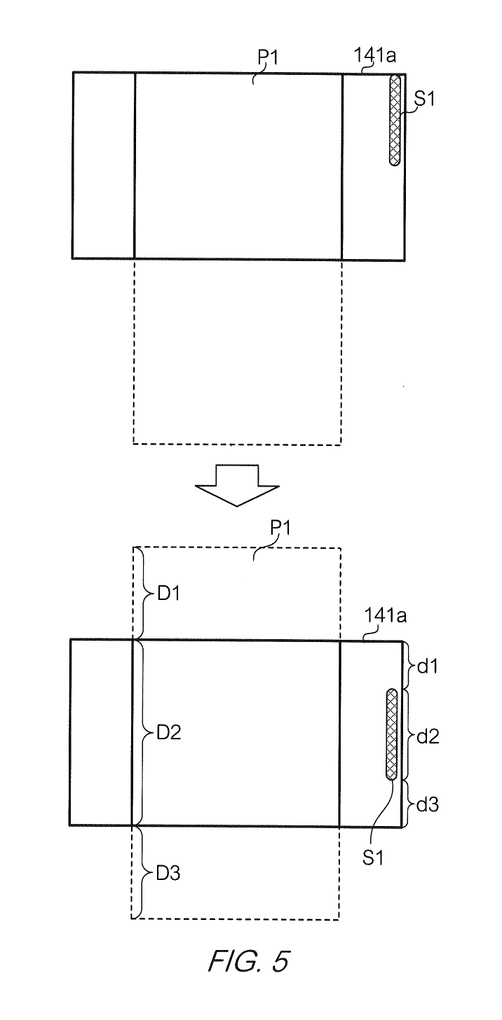

FIGS. 3 and 4 are diagrams showing an example of a method for displaying web page P1. FIG. 3 is a diagram showing a display method in which web page P1 is displayed in the entirety of display area 141 a (referred to hereinafter as “entire screen display”). On the other hand, FIG. 4 is a diagram showing a display method in which web page P1 is displayed in part of display area 141a. In the present embodiment, the user can enlarge and reduce the size of the web page P1 display area (referred to hereinafter as the “page area”). The width of the page area changes according to the display scale factor of web page P1. Specifically, the width of the page area grows longer as the display scale factor of web page P1 increases, and grows shorter as the display scale factor of web page P1 decreases. Note that the page area corresponds to an example of the first area of the present embodiment.

Note that the web page can include vertically-long content in the present embodiment. Accordingly, there are cases where the entirety of a web page cannot be displayed in the page area in terms of the vertical direction, and only part of the web page is displayed. Note that since the vertical length of a web page can differ from page to page, the web page may of course be a web page whose entirety can be displayed in the page area at a single time.

As shown in FIG. 4, if the width (length in the horizontal direction) of the page area is shorter than the width of display area 141a itself, an area other than the page area appears in display area 141a. Although an image does not need to be displayed in this area, an image other than web page P1 displayed in the page area may be displayed. Note that this area is referred to as a “blank area” in the following description for the sake of convenience. In other words, “blank” as used herein does not refers to only the state in which the color is white or nothing is rendered, but rather refers to the state in which web page P1 is not displayed.

In FIG. 4, reference sign S1 denotes a scroll indicator. Scroll indicator S1 is an image for indicating the displayed position of web page P1 being displayed in display area 141a, if the height (length in the vertical direction) of web page P1 is longer than the height of display area 141a. Also, scroll indicator S1 is displayed at a predetermined position with respect to the horizontal direction. In the present embodiment, this predetermined position in the right edge of display area 141a. Displaying scroll indicator S1 at a constant position allows the user to always check it in the same place. Note that as shown in FIG. 3, scroll indicator S1 is not displayed when the blank area is not present.

Also, in the present embodiment, scroll indicator S1 is displayed such that its position in the vertical direction changes according to the actual displayed position of web page P1. If the displayed position of web page P1 is the top portion of the web page, scroll indicator S1 is displayed in the top portion of the display area, and if the displayed position of web page P1 is the bottom portion of the web page, scroll indicator S1 is displayed in the bottom portion of the display area. Also, the position of scroll indicator S1 in the vertical direction changes in accordance with a scroll operation performed by the user on web page P1.

FIG. 5 is a diagram for describing the relationship between the displayed position of web page P1 and the position of scroll indicator S1. As shown in FIG. 5, the position of scroll indicator S1 is controlled such that the ratio of D1 to D2 to D3 is the same as the ratio of d1 to d2 to d3 (i.e., such that D1:D2:D3=d1:d2:d3 is satisfied). Note that in FIG. 5, the portion of web page. P1 indicated with broken lines is the portion that is not actually displayed in display area 141a.

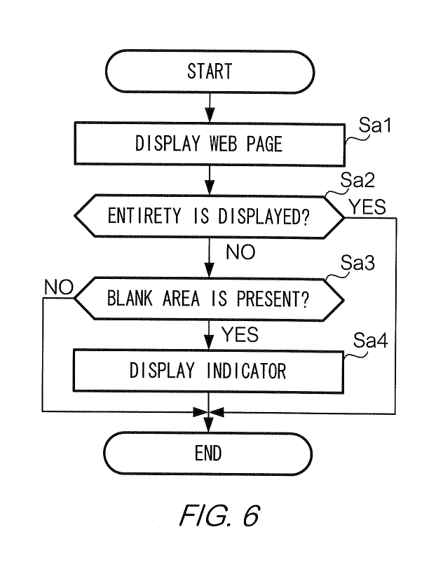

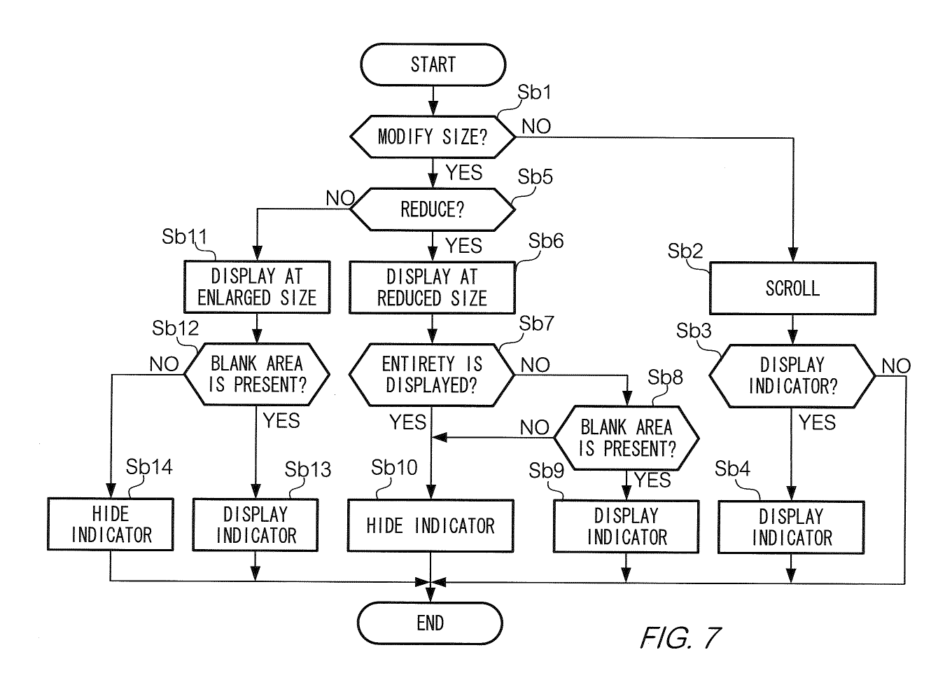

FIGS. 6 and 7 are flowcharts showing the above-described display control. FIG. 6 shows basic processing performed when a web page is to be displayed. On the other hand, FIG. 7 shows interrupt processing whose execution is triggered by a user operation performed after a web page is displayed. This processing is processing for rewriting the web page displayed in the page area (or the page area itself), and is referred to as “rewrite processing” in the following description. Note that although various operations can be envisioned as user operations, only a scroll operation and a size modification operation will be described here as user operations for the sake of convenience. Also, the size modification operation can specifically be an “enlargement operation” for enlarging the size of the display of the web page or a “reduction operation” for reducing the size of the display of the web page.

As shown in FIG. 6, control unit 110 of information processing apparatus 100 first displays a web page on display unit 141 (step Sa1). At this time, control unit 110 acquires data for displaying the web page via communication unit 130, as well as generates display data by performing rendering or the like and displays the web page by supplying the display data to display unit 141.

At this time, control unit 110 determines whether the entirety of the web page is being displayed in the page area (step Sa2). If the entirety of the web page is being displayed in the page area, control unit 110 skips subsequent processing and ends this procedure since there is no need to display the scroll indicator. On the other hand, if the entirety of the web page is not being displayed in the page area, control unit 110 determines whether a blank area is included in the display area (step Sa3).

If a blank area is included in the display area, control unit 110 executes processing for displaying the scroll indicator (referred to hereinafter as “indicator display processing”) (step Sa4). Specifically, the indicator display processing is processing for specifying the displayed position of the web page and displaying the scroll indicator at a position that corresponds to the specified displayed position (FIG. 5). Also, if a blank area is not included in the display area, control unit 110 skips (omits) the indicator display processing and ends this procedure.

Note that in order to specify the displayed position of the web page, control unit 110 needs to detect it through calculation or the like. Control unit 110 may detect the displayed position of the web page each time the indicator display processing is executed. Also, in a multitasking environment, a configuration is possible in which control unit 110 always executes processing in the background for detecting the displayed position of the web page while the web page is being displayed, and specifies the displayed position of the web page by reading out the result of this processing.

After the web page is displayed in this way, the rewrite processing shown in FIG. 7 is executed if the user performs an operation (scroll operation or size modification operation) on the web page. The scroll operation may be, for example, an operation in which the user directly touches and drags the page area, or may be an operation in which the user presses an arrow key or the like. The size modification operation may also be a touch operation or an operation in which a predetermined key is pressed.

In the rewrite processing, control unit 110 determines which operation was performed by the user, and executes processing that corresponds to the determination result. First, control unit 110 determines whether the user operation is the scroll operation or the size modification operation (step Sb1).

If the user operation is the scroll operation, control unit 110 scrolls the web page by moving the displayed position of the web page by an amount that corresponds to the user operation (scroll amount) (step Sb2). At this time, control unit 110 scrolls the web page by moving it in the upward direction or the downward direction. Also, control unit 110 determines whether the scroll indicator is being displayed at this time (step Sb3). Note that control unit 110 may determine whether a blank area is present, in place of the processing of step Sb3.

If the scroll indicator is being displayed, control unit 110 executes indicator display processing and moves the scroll indicator in the upward direction or the downward direction in accordance with the web page scroll amount (step Sb4). On the other hand, if the scroll indicator is not being displayed, control unit 110 skips the indicator display processing.

Next, if the user operation is the size modification operation, control unit 110 determines whether the size modification operation is the reduction operation or the enlargement operation (step Sb5), and executes processing that corresponds to the determination result.

If the user operation is the reduction operation, control unit 110 displays the web page at a reduced size (step Sb6). At this time, control unit 110 also modifies the size (width) of the page area itself in conformity with the web page size modification. If the web page is displayed at a reduced size, there is a rise in the ratio of the portion of the web page that is included in the page area, and therefore the amount of information in the page area rises. Accordingly, if the reduction operation is performed, there is the possibility that whereas the entirety of the web page had not been displayed in the page area, the entirety of the web page will be displayed in the page area.

In view of this, control unit 110 determines whether the entirety of the web page will be displayed in the page area after the reduction (step Sb7), and if the entirety of the web page will not be displayed even after the reduction, control unit 110 determines whether a blank area will be included in the display area (step Sb8). If the blank area will be included in the display area, control unit 110 executes the indicator display processing and displays the scroll indicator in the blank area (step Sb9).

On the other hand, if the entirety of the web page will be displayed in the page area after the reduction, control unit 110 hides the scroll indicator that had been displayed up until then (step Sb10). The reason for this is that if the entirety of the web page is displayed in the page area, it can be said that the scroll indicator is no longer necessary. Similarly, control unit 110 hides the scroll indicator if it is determined in step Sb8 that a blank area will not be included in the display area.

Next, if the user operation is the enlargement operation, control unit 110 displays the web page at an enlarged size (step Sb11). At this time, control unit 110 also modifies the size (width) of the page area itself in conformity with the web page size modification. Since the user operation is the enlargement operation, the width of the page area will be longer in this case than it was before the enlargement.

At this time, control unit 110 determines whether a blank area is included in the display area (step Sb12). If the blank area is included in the display area, control unit 110 executes the indicator display processing and displays the scroll indicator in the blank area (step Sb13). On the other hand, if a blank area disappears from the display area as a result of the enlargement operation, control unit 110 hides the scroll indicator (step Sb14).

As described above, according to information processing apparatus 100, a configuration is possible in which if a blank area is included in the display area, the scroll indicator is displayed in the blank area, and if a blank area is not included in the display area and the web page is being displayed in the entirety of the display area, the scroll indicator is hidden. This makes it possible to display the scroll indicator without being superimposed on the web page so as to prevent it from hindering the view of the web page.

In the present embodiment, the scroll indicator is not displayed when the web page is displayed at a certain display scale factor, and the scroll indicator is displayed when the web page is displayed at a display scale factor that is lower than the certain display scale factor. In general, the case of displaying a web page at a reduced size includes cases such as the case of getting an overview of the information in the web page. Also, the amount that the page is scrolled when the user performs the scroll operation increases if the web page is displayed at a reduced size (i.e., when the page is scrolled the same distance, the actual movement amount is higher if the page is displayed at a reduced size), and this is advantageous in cases such as when there is a desire to quickly find a desired place out of the entirety of a long web page. In the present embodiment, a blank area that appears when a web page is displayed at a size smaller than its size in entire screen display is utilized, and the scroll indicator is displayed in that blank area. According to this configuration, the scroll indicator can be prevented from hindering the view of the web page, while achieving the original function of the scroll indicator.

On the other hand, the case of displaying a web page at an enlarged size mainly includes cases such as when there is a desire to perform a detailed check of characters or the like included in a web page. Since focus is often placed on details in the page in such cases, attention is often not given to other portions. For this reason, it can be said that there is no significant disadvantage even if the scroll indicator is not displayed in such cases. Reasons for this include the fact that the scroll indicator is for indicating which portion of the web page corresponds to the position of the portion of the web page that is actually being displayed, and the fact that the scroll indicator is often unnecessary when checking details of information such as this.

### 3. Variations

The above-described embodiment is one aspect of the present embodiment. The present embodiment is not limited to this embodiment, and can be carried out according to aspects such as those described in the following variations. Note that the following variations can also be applied in various combinations as necessary.

### Variation 1

The content of the present embodiment is not limited to a web page. The content of the present embodiment is not limited to being acquired from an external device and then displayed, but rather can be a so-called local file that is internally stored in the apparatus, for example.

Also, the content of the present embodiment may be scrolled in the horizontal direction instead of being scrolled in the vertical direction as in the above-described embodiment, and may be able to be scrolled in both the vertical direction and the horizontal direction.

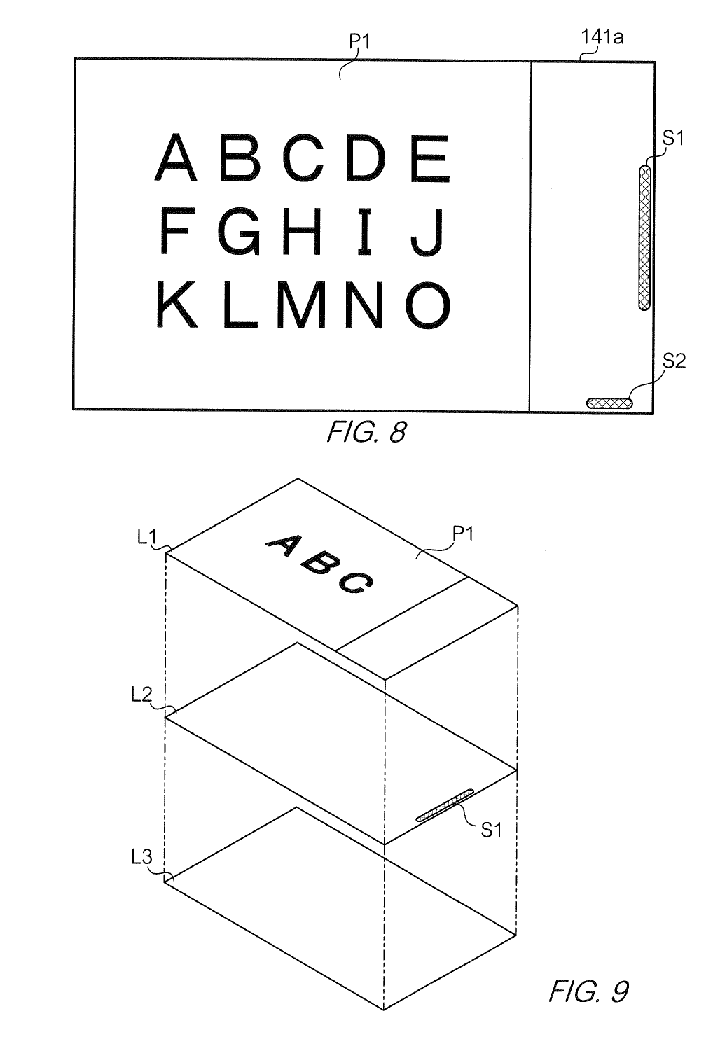

FIG. 8 is a diagram showing an example of display when content can be scrolled in both the vertical direction and the horizontal direction. In this case, information processing apparatus 100 displays scroll indicator S1 and scroll indicator S2 in a blank area. Scroll indicator S1 is an image representing the displayed position of web page P1 in the vertical direction, and scroll indicator S2 is an image representing the displayed position of web page P1 in the horizontal direction.

### Variation 2

In the above-described embodiment, when size of the page area is enlarged or reduced, the display scale factor of the web page in the page area is accordingly enlarged or reduced. However, information processing apparatus 100 may modify only the size of the page area, without modifying the display scale factor of the web page. In this case, control unit 110 functions as a unit for modifying the width (or height) of the page area, instead of functioning as a unit for modifying the display scale factor of the web page. For example, in the case of receiving an operation for scrolling the web page in the horizontal direction, control unit 110 may modify the width of the page area in accordance with the movement of the web page.

Also, in the present embodiment, the display size of the content in the display area may be determined in advance. For example, in the case of a web page, the window size can be designated using HTML (HyperText Markup Language) data or a script. In a case such as this, a configuration is possible in which the information processing apparatus 100 compares the size of the display area and the size of the web page, displays the scroll indicator in a blank area if the size of the display area is larger than the size of the web page and a blank area appears, and does not display the scroll indicator if a blank area does not appear. More specifically, if the width of the web page is shorter than the width of the display area, for example, information processing apparatus 100 displays the scroll indicator, and if the width of the web page is longer than the width of the display area, information processing apparatus 100 displays the web page in the entirety of the display area by setting the width of the page area so as to match the width of the display area.

### Variation 3

The display control for realizing the present embodiment may be a method that employs layers as described below.

FIG. 9 is a diagram showing an example of a layer structure. In FIG. 9, layer L1 is the top layer that is allocated to the web page. Also, layer L2 is the layer that is allocated to the scroll indicator, and layer L3 is the bottom layer that is allocated to the blank area. Here, the higher the layer is, the more toward the foreground it is displayed, and an image in a lower layer that is overlapped with an image in a higher layer is not displayed due to being overwritten.

In this example, information processing apparatus 100 always executes rendering for each layer. In other words, regardless of whether the web page P1 is to be displayed in the entirety of the display area, information processing apparatus 100 continues to execute processing for rendering scroll indicator S1 and the blank area. Information processing apparatus 100 then displays scroll indicator S1 if web page P1 is not present in front of scroll indicator S1, and prevents the display of display scroll indicator S1 if web page P1 is present in front of scroll indicator S1.

### Variation 4

In the present embodiment, there may be only two page area sizes, namely a first size (entire screen display) and a second size (a size smaller than entire screen display), or there may be more page area sizes. Also, information processing apparatus 100 may be configured such that the size of the page area can be smoothly modified by a pinch operation, which is a type of touch operation. The pinch operation referred to here is an operation in which two points in the display area are touched and then moved closer together or farther from each other without separation from the display area. In this case, information processing apparatus 100 makes the page area smaller in accordance with an operation for moving the two points closer together (pinch-in operation), and makes the page area larger in accordance with an operation for moving the two points farther from each other (pinch-out operation).

### Variation 5

The indicator of the present embodiment may be an indicator whose displayed position can be modified. In other words, there may be multiple positions at which the indicator of the present embodiment can be displayed. For example, information processing apparatus 100 may be configured such that the scroll indicator can be displayed at either the right edge or the left edge of the display area, and the user can set one of the edges in advance. Also, information processing apparatus 100 may determine the position at which the blank area appears in the display area, and display the scroll indicator so as to overlap with the blank area. For example, information processing apparatus 100 can also determine the displayed position of the scroll indicator according to the content display state, such as displaying the scroll indicator at the right edge if the blank area is at the right edge of the display area, and displaying the scroll indicator at the left edge if the blank area is at the left edge of the display area.

### Variation 6

The indicator of the present embodiment is not limited to being a scroll indicator, and may be a scrollbar. Also, the indicator of the present embodiment is not limited to indicating the displayed position of the content using a bar-shaped graphic, and may indicate the displayed position of the content using a character or a color. For example, if the content is a document made up of multiple pages, the indicator may be an image that indicates the page number of the page that is being displayed at the time.

### Variation 7

The information processing apparatus of the present embodiment is not limited to above-described information processing apparatus 100. The information processing apparatus of the present embodiment does not need to be a handheld gaming device, and may be, for example, a stationary gaming device or a device other than a gaming device, such as a smartphone, a tablet terminal, or a portable music player. Also, the information processing apparatus of the present embodiment does not necessarily need a communication unit.

Note that with the information processing apparatus of the present embodiment, the input unit does not need to be included in the information processing apparatus itself. For example, in place of the input unit, the information processing apparatus of the present embodiment may be configured including a unit for acquiring operation data from an input apparatus such as a remote controller. Also, the input unit is not limited to above-described sensor unit 142 and input unit 150, and may be configured such that, for example, scroll operations are performed with an infrared sensor or a motion sensor (e.g., a gyroscope or an accelerometer).

Also, the information processing apparatus of the present embodiment does not need to include the display unit. Specifically, if a display apparatus that has a display unit is provided separately, the information processing apparatus of the present embodiment may be configured as a display control apparatus for controlling the display performed by the display apparatus.

### Variation 8

The present embodiment is not limited to the modes of a display control apparatus or an information processing apparatus that includes a display control apparatus, and can also be carried out in the mode of a display control system that includes multiple apparatuses among which configurations corresponding to the display control apparatus are distributed. For example, the display control system of the present embodiment may be configured including a display apparatus provided with a display unit, and a control apparatus that can access the display apparatus via a network such as the Internet, and the functions of the display control apparatus or the information processing apparatus of the present embodiment may be realized through cooperation of the display apparatus and the control apparatus. Alternatively, the display control system of the present embodiment may be realized by cooperation between a first apparatus that corresponds to a master device, and a second apparatus that corresponds to a slave device and is connected to the first apparatus via a wired or wireless connection. The first apparatus referred to here may be a personal computer or a home gaming device, and the second apparatus may be a remote controller or tablet terminal that can perform communication with the first apparatus.

Also, the present embodiment is not limited to modes such as the information processing apparatus or the display control system, and can also be implemented in modes such as the mode of a display method for displaying the indicator only if the second area is present, and the mode of an information processing program for realizing this display method. Furthermore, the information processing program of the present embodiment can be provided in the mode of being recorded on a recording medium such as an optical disc or a semiconductor memory, or may be provided in the mode of being downloaded to the information processing apparatus via a network such as the Internet.

The foregoing description of the embodiments is provided for the purposes of illustration and description. Obviously, a large number of possible modifications and variations will be apparent to practitioners skilled in the art. The embodiments were chosen and described in order to best explain the principles of the technology and its practical applications, thereby enabling others skilled in the art to understand the technology in various embodiments, and with the various modifications as suited to a particular use that may be contemplated.

What is claimed is:

1. A display control apparatus comprising:
a first display controller that displays a portion of content in a predetermined area in a display area;
a position detector that detects a position of the portion of content being displayed in the predetermined area; and
a second display controller that, if the display area includes a blank area in which the portion of content is not being displayed, displays a scroll indicator indicative of the detected position in the blank area, and if the display area does not include the blank area, prevents display of the scroll indicator.

2. A display control apparatus comprising:
a position detector that, if a portion of content is being displayed in a first area in a display area, detects a position of the portion of content being displayed in the first area; and
a display controller that, if the display area includes a second area that is different from the first area, displays an indicator indicative of the position detected by the position detector in the second area, and if the display area does not include the second area, prevents display of the indicator.

3. The display control apparatus according to claim 2, further comprising:
a modification unit that modifies the length of the first area in a predetermined direction,
wherein if the second area appeared due to a modification performed by the modification unit, the display controller displays the indicator in the second area.

4. The display control apparatus according to claim 3,
wherein the modification unit modifies the length of the first area in the predetermined direction in accordance with an input made by a user via an input device.

5. The display control apparatus according to claim 3,
wherein the modification unit modifies the length of the first area in the predetermined direction by reducing the size of the content.

6. The display control apparatus according to claim 5,
wherein the display controller scrolls the content in accordance with an input made by a user via an input device after the size of the content was reduced.

7. The display control apparatus according to claim 2,
wherein the display controller displays the indicator at a predetermined position in the display area.

8. The display control apparatus according to claim 7,
wherein the display controller selects the predetermined position overlapping the second area from a plurality of predetermined positions.

9. The display control apparatus according to claim 2,
wherein the predetermined direction is one of a vertical direction and a horizontal direction of the display area, and
the display controller displays the indicator in only one of the vertical direction and the horizontal direction.

10. A non-transitory readable medium storing a program that causes a computer to execute:
if a portion of content is being displayed in a first area in a display area, detecting a position of the portion of content being displayed in the first area; and
if the display area includes a second area that is different from the first area, displaying an indicator indicative of the detected position in the second area, and if the display area does not include the second area, preventing display of the indicator.

11. A display control system comprising:
a position detector that, if a portion of content is being displayed in a first area in a display area, detects a position of the portion of content being displayed in the first area; and
a display controller that, if the display area includes a second area that is different from the first area, displays an indicator indicative of the position detected by the position detector in the second area, and if the display area does not include the second area, prevents display of the indicator.

12. A display method comprising:
if a portion of content is being displayed in a first area in a display area, detecting a position of the portion of content being displayed in the first area; and
if the display area includes a second area that is different from the first area, displaying an indicator indicative of the detected position in the second area, and if the display area does not include the second area, preventing display of the indicator.
